(19) United States
(12) Patent Application Publication
(10) Pub. No.: US 2009/0043891 A1
(43) Pub. Date: Feb. 12, 2009

(54) Mobile WiMax network system including private network and control method thereof

(76) Inventors: Moo-Yeon Woo, Suwon-si (KR); Gui-Jung Lee, Yongin-si (KR); Dong-Youl Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/000,926

(22) Filed: Dec. 18, 2007

(30) Foreign Application Priority Data
Aug. 10, 2007 (KR) 10-2007-0080867

(51) Int. Cl. G06F 15/173

(52) U.S. Cl. 709/225

(57) ABSTRACT

A mobile Worldwide Interoperability for Microwave Access (WiMax) network system is provided with a private network including a WiMax Control Management (WCM) server managing identification information of terminals, and a private access control router. When an arbitrary terminal requests Internet protocol address assignment after an authentication procedure of the mobile WiMax network system is performed, the private access control router determines whether the arbitrary terminal is registered in the WiMax Control Management (WCM) server in dependence upon identification information of the terminal acquired by communicating with the WiMax Control Management (WCM) server. If the arbitrary terminal is registered in the WiMax Control Management (WCM) server, the private access control router assigns preset private network information to the terminal and to the private network.

### CLAIM OF PRIORITY

This application makes reference to, incorporates the same herein, and claims all benefits accruing under 35 U.S.C. §119 from an application earlier filled in the Korean-Intellectual Property Office on 10 Aug. 2007 and there duly assigned Serial No. 10-2007-0080867.

### BACKGROUND OF THE INVENTION

1. Field of the Invention

The present invention relates to a method for providing a public wireless network service by interworking with an existing mobile Worldwide Interoperability for Microwave Access (WiMax) system and simultaneously providing voice and data services by interworking with a Private Branch eXchange (PBX) and a local intranet for local subscribers in a local area.

2. Description of the Related Art

As a technology for a local intranet service in a mobile WiMax system, Korean Patent Application No. 10-2004-0087848 entitled “SYSTEM AND METHOD FOR WIRELESS INTRANET SERVICE BASED ON PORTABLE INTERNET” has been filed by SK TELECOM CO LTD.

This contemporary method requests a system constructed with a private access control router, a Radio Access Station (RAS), and an intranet server, and additionally requires an access control router for a public network in a Core Node (CN).

In an operation scenario, a user may receive a desired local service using an assigned Internet Protocol (IP) address associated with an intranet by running a local service access program of a terminal. The user may not access the Core Node (CN).

On the other hand, when desiring to receive a service by accessing the Core Node (CN), a user may use an assigned IP address associated with the Core Node (CN) by releasing the local service access program and running a Core Node (CN) access program in the terminal. In this case, there is a problem in that the intranet service may not be received.

This contemporary technology requires an additional private access control router by separating the private access control router from the access control router in an existing public network Core Node (CN).

Moreover, in the contemporary technology, the user may not simultaneously receive the local intranet service and the public network Core Node (CN) service.

The user should directly run a program for accessing the public network Core Node (CN) service to receive the public network Core Node (CN) service and also should directly run a program for accessing the local intranet service to receive the local intranet service.

Since an IP address assigned to the terminal differs according to the location to be accessed, two services may not be simultaneously enabled and received.

There is a problem in that this method is inconvenient for the user, and it is difficult for the user to receive a service to which the subscriber should be constantly connected like a voice service through Voice over IP (VoIP).

### SUMMARY OF THE INVENTION

It is therefore an object of the present invention to provide an improved mobile WiMax network system and an improved control method for the mobile WiMax network system.

It is another object of the present invention to solve the foregoing problems of the prior art and to provide a mobile WiMax network system including a private network and a control method thereof that can provide local voice and video call services through a Private Branch eXchange (PBX) in a local area, and that can provide a data service through an intranet to a local subscriber of a mobile access terminal which is capable of simultaneously accessing a mobile WiMax network and a local intranet network.

It is still another object of the present invention to provide a mobile WiMax network system including a private network and a control method thereof that can provide a security function for providing a non-subscriber of a mobile WiMax terminal with the same level service as that in an external area when the non-subscriber enters a local area and simultaneously preventing the non-subscriber from accessing to a local intranet network.

It is a further object of the present invention to provide a mobile WiMax network system including a private network and a control method thereof that can provide remote access through a Virtual Private Network (VPN) such that a local subscriber of a mobile WiMax terminal can receive a voice/video call service through a Private Branch eXchange (PBX) of a local area network and a data service through an intranet in an external area.

According to an aspect of the invention, a mobile Worldwide Interoperability for Microwave Access (WiMax) network system is provided with a private network including a WiMax Control Management (WCM) server managing identification information of terminals, and a private access control router. When an arbitrary terminal requests Internet protocol address assignment after an authentication procedure of the mobile WiMax network system is performed, the private access control router determines whether the arbitrary terminal is registered in the WiMax Control Management (WCM) server in dependence upon identification information of the terminal acquired by communicating with the WiMax Control Management (WCM) server. If the arbitrary terminal is registered in the WiMax Control Management (WCM) server, the private access control router assigns preset private network information to the terminal and to the private network.

Preferably, the identification information of the terminal is a media access control address, and the private network information is about an IP subnet.

Preferably, the private network further includes a first firewall for authorizing the terminal to access the private network by setting a private network IP address registered in the WiMax Control Management (WCM) server and assigning the private network IP address to the terminal with reference to a security policy.

Preferably, the private access control router assigns an IP address of the mobile WiMax network to a terminal after the terminal is authenticated through the mobile WiMax network when the terminal which is not registered in the WiMax Control Management (WCM) server makes an access request.

The private access control router may route a packet to an Internet through a core node when the packet destined to the Internet is sent from an arbitrary terminal.

Alternatively, the private access control router may send a packet to an Internet through the private network after checking a source IP address of the packet when the packet destined to the Internet is sent from an arbitrary terminal.

Preferably, the private network further includes a private authenticator for authenticating a registered terminal.

Preferably, the private network is connected to an external public switched telephone network to provide a voice service through a voice over IP.

Preferably, the private network further includes a Virtual Private Network (VPN) server, connected to a core node, for providing a Virtual Private Network (VPN) function using one of a point-to-point tunneling protocol, a layer two tunneling protocol, and an Internet protocol security protocol.

Preferably, the private network is set to at least one private network according to the private network information of the terminals.

According to another aspect of the invention, a control method of a mobile WiMax network system interworking with a private network is provided. According to the control method, identification information of terminals are managed in a WiMax Control Management (WCM) server of the private network; a private access control router determines whether an arbitrary terminal is registered in the WiMax Control Management (WCM) server in dependence upon the identification information of the terminal acquired by communicating with the WiMax Control Management (WCM) server after mobile WiMax authentication is performed for the terminal requesting access; and preset private network information is assigned by the private access control router to the terminal and to the private network when the terminal is determined to be registered.

Preferably, the identification information of the terminal is a media access control address, and the private network information is about an IP subnet.

Preferably, the control method further includes authorizing, by a first firewall, the terminal to access the private network by setting a private network IP address registered in the WiMax Control Management (WCM) server and assigning the to private network IP address to the terminal with reference to a security policy.

Preferably, the control method further includes assigning an IP address of the mobile WiMax network by the private access control router to a terminal after the terminal is authenticated through the mobile WiMax network when the terminal which is not registered in the WiMax Control Management (WCM) server makes an access request.

The control method may further include routing a packet by the private access control router to an Internet through a core node when the packet destined to the Internet is sent from an arbitrary terminal.

Alternatively, the control method may further include routing a packet by the private access control router to an Internet through the private network after checking a source IP address of the packet when the packet destined to the Internet is sent from an arbitrary terminal.

Preferably, the control method further includes connecting to an external public switched telephone network to provide a voice service through a voice over IP, accessing a core node through a Virtual Private Network (VPN) server, and providing a Virtual Private Network (VPN) function using one of a point-to-point tunneling protocol, a layer two tunneling protocol, and an Internet protocol security protocol.

Preferably, at least one private network is set according to the private network information of the terminals.

In accordance with the invention as described above, a mobile WiMax network system including a private network and a control method thereof do not require an additional access control router by processing a local intranet service and a public network Core Node (CN) service in one private access control router and can allow a local subscriber to simultaneously receive the local intranet service and the public network Core Node (CN) service without a special operation in the local subscriber's terminal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a functional block diagram illustrating a configuration of a mobile WiMax network system including a contemporary private network;

FIG. 2 is a functional block diagram illustrating a configuration of a mobile WiMax network system including a private network constructed as an embodiment according to the principles of the present invention;

FIG. 3 illustrates an access process of a terminal subscribed in a local area in the mobile WiMax network system including the private network as shown in FIG. 2;

FIG. 4 illustrates an Internet access process of the terminal subscribed in the local area in the mobile WiMax network system including the private network as shown in FIG. 2;

FIG. 5 illustrates remote access to a local intranet using a Virtual Private Network (VPN) in the mobile WiMax network system including the private network as shown in FIG. 2;

FIG. 6 illustrates a model interworking with at least one private network in the mobile WiMax network system including the private network as shown in FIG. 2; and

FIG. 7 is a flowchart illustrating a method for controlling the mobile WiMax network system including the private network in accordance with the invention.

### DETAILED DESCRIPTION OF THE PREFERRED INVENTION

The invention will now be described more fully hereinafter with reference to the accompanying drawings, in which preferred embodiments of a mobile WiMax network system including a private network and a control method thereof in accordance with the invention are shown. Those skilled in the art should understand that a system configuration as described below is illustrative for the invention and does not limit the invention.

As a technology for a local intranet service in a mobile WiMax system, Korean Patent Application No. 10-2004-0087848 entitled “SYSTEM AND METHOD FOR WIRELESS INTRANET SERVICE BASED ON PORTABLE INTERNET” has been filed by SK TELECOM CO LTD.

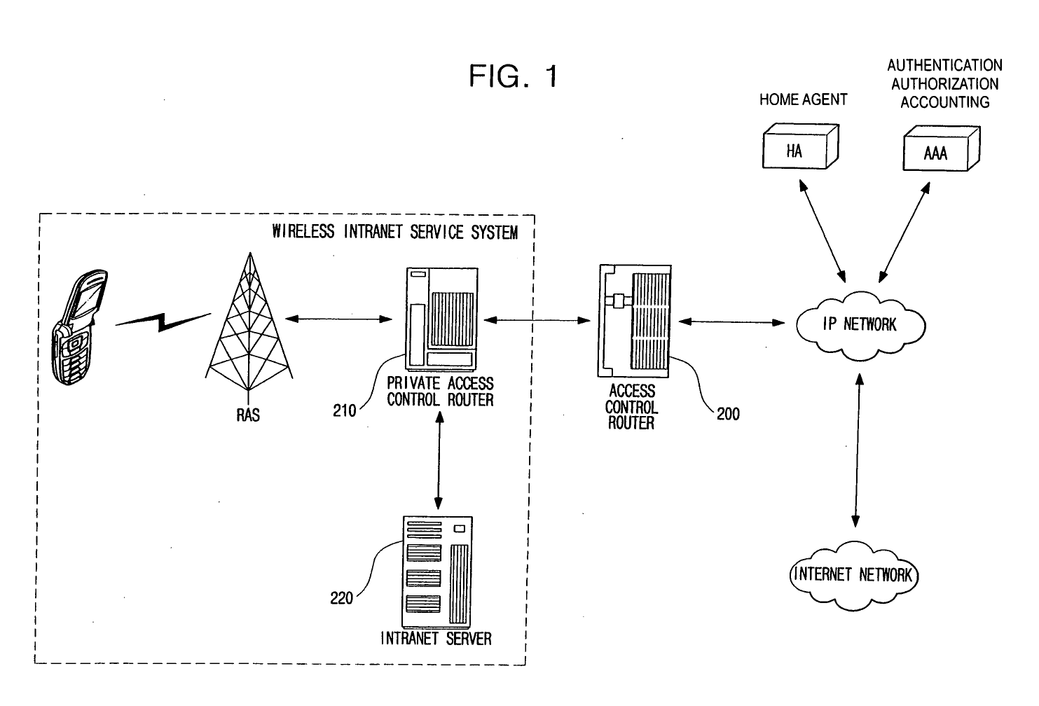

FIG. 1 is a functional block diagram illustrating a configuration of a mobile WiMax network system including a contemporary private network. This mobile WiMax network is constructed with a private access control router 210, a Radio Access Station (RAS) (not denoted by reference numeral), and an intranet server 220, and additionally requires an access control router 200 for a public network in a Core Node (CN).

Referring to an operation scenario, when desiring to receive a local service, a user may use an assigned Internet Protocol (IP) address associated with an intranet by running a local service access program in a terminal. In this case, however, the user may not access the Core Node (CN).

On the other hand, when desiring to receive a service by accessing the Core Node (CN), a user may receive the Core Node (CN) service using an assigned IP address associated with the Core Node (CN) by releasing the local service access program and running a Core Node (CN) access program in the terminal. In this case, there is a problem in that the intranet service may not be received.

This contemporary technology requires the additional private access control router 210 by separating private access control router 210 from access control router 200 for an existing public network Core Node (CN).

Moreover, in the contemporary technology, the user may not simultaneously receive the local intranet service and the public network Core Node (CN) service.

The user should directly run a program for accessing the public network Core Node (CN) service to receive the public network Core Node (CN) service and also should directly run a program for accessing the local intranet service to receive the local intranet service.

Since an IP address assigned to the terminal differs according to the point to be accessed, two services may not be simultaneously enabled and received.

There is a problem in that this method is inconvenient for the user, and it is difficult for the subscriber to receive a service to which the subscriber should be constantly connected like a voice service through Voice over IP (VoIP).

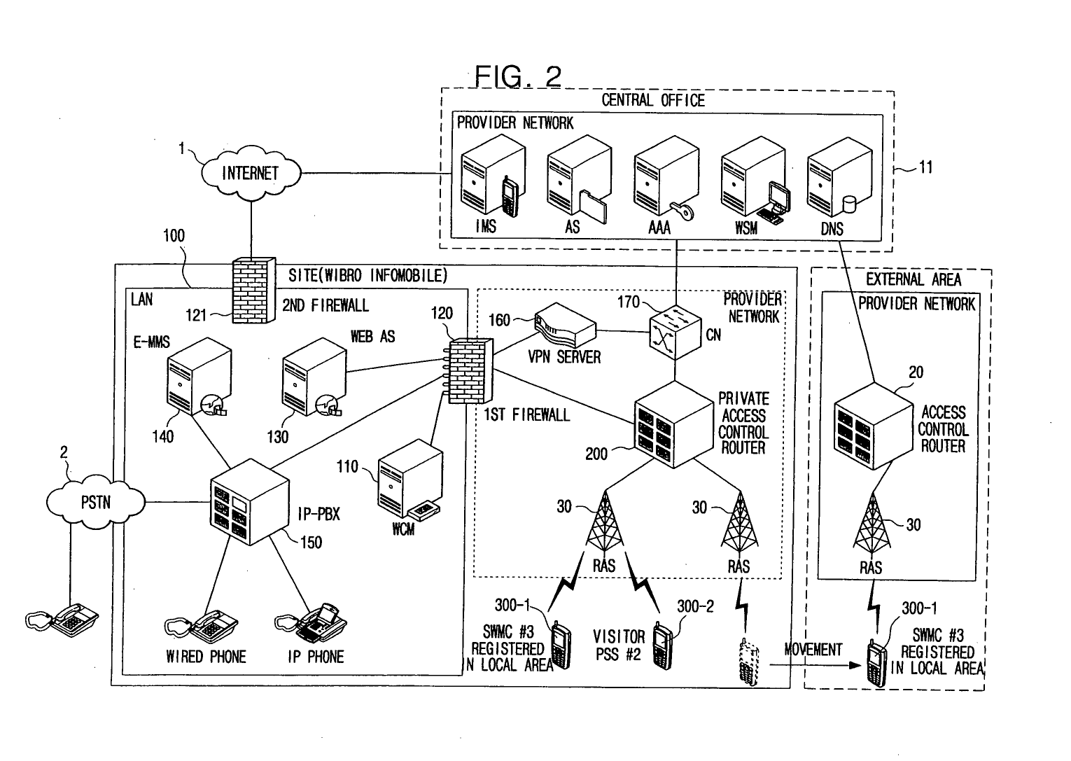

FIG. 2 is a functional block diagram illustrating a configuration of a mobile WiMax network system including a private network constructed as an embodiment according to the principles of the present invention. The mobile WiMax network system including the private network in accordance with the invention is constructed with a private network 100 having a WiMax Control Management (WCM) server 110 and a private access control router 200.

This mobile WiMax network system further includes a provider network 11 including an IP Multimedia Subsystem (IMS), an Application Server (AS), an Authentication, Authorization, and Accounting (AAA) server, a WiMax Service Management (WSM) server, and a Domain Name System (DNS), an access control router 20, and an Radio Access Station (RAS) 30. The mobile WiMax network system can interwork with the private network 100.

Private network 100 further includes a first firewall 120 having a Network Address Translation (NAT) function, a web Application Server (AS) 130, an Electronic-Multimedia Messaging Service (E-MMS) server 140, an IP Private Branch eXchange (IP-PBX) 150, and a second firewall 121 connected to Internet 1.

Private network 100 further includes a Virtual Private Network (VPN) server 160 located in a provider network that is located in a local side of private network. In a WiMax network, remote access is performed through Virtual Private Network (VPN) server 160.

Herein, WiMax Control Management (WCM) server 110 is a server for compositely providing a plurality of functions as follows. WiMax Control Management (WCM) server 110 provides a function for authenticating a local subscriber. When a mobile WiMax terminal 300-1 requests IP assignment, WiMax Control Management (WCM) server 110 determines whether mobile WiMax terminal 300-1 is a local subscriber when private access control router 200 asks whether mobile WiMax terminal 300-1 is the local subscriber, and then provides private access control router 200 with a determination result. Moreover, subscriber authentication can be performed by directly interworking with mobile WiMax terminal 300-1.

WiMax Control Management (WCM) server 110 provides a Short Message Service (SMS) to mobile WiMax terminal 300-1 or 300-2 and uses a Session Initiation Protocol (SIP) for providing the Short Message Service (SMS).

WiMax Control Management (WCM) server 110 provides a Security Management Center (SMC) function. That is, WiMax Control Management (WCM) server 110 can control various functions of a camera of mobile WiMax terminal 300-1, of Universal Serial Bus (USB) communication, of a storage medium, of an MPEG-1 Audio Layer-3 (MP3) player, and the like, and can enhance security for a company by disabling an associated function in the local area.

A private Domain Name System (pDNS) function is provided. That is, Uniform Resources Locator (URL) access is provided for user convenience when mobile WiMax terminal 300-1 accesses a server of a local intranet. Since the associated Uniform Resources Locator (URL) is for the local intranet server and the associated information is absent in a Domain Name System (DNS) server of an Internet network, WiMax Control Management (WCM) server 110 additionally has the private Domain Name System (pDNS) function.

A Remote Authentication Dial In User Service/Certificate Authority (RADIUS/CA) function is performed. That is, mobile WiMax terminal 300-1 or 300-2 not only can have access in the local area, but also can access the local area via Virtual Private Network (VPN) server 160 from a region far away from the local area, where the mobile WiMax network is installed. When remote access is performed via a Virtual Private Network (VPN) from an external area, the Remote Authentication Dial In User Service/Certificate Authority (RADIUS/CA) function for Virtual Private Network (VPN) access authentication is provided.

A Policy Decision Function (PDF) is performed. That is, when a Voice over IP (VoIP) service is provided through mobile WiMax terminal 300-1 or 300-2, it is important to secure Quality of Service (QoS) in a wireless zone for voice quality. WiMax Control Management (WCM) server 110 provides the Policy Decision Function (PDF) for controlling the Quality of Service (QoS) according to service type.

WiMax Control Management (WCM) server 110 provides the following functions for local intranet services to mobile WiMax terminal 300-1 through a Security WiMax Control Management (WCM) Mobile Center (i.e., a SWMC) serving as a private authenticator.

An authentication function authenticates a local subscriber by interworking with WiMax Control Management (WCM) server 110.

A Voice over IP (VoIP) function provides voice and video call services by interworking with IP Private Branch eXchange (IP-PBX) 150 located in the local area and the Session Initiation Protocol (SIP).

A Multimedia Messaging Service (MMS) function provides various multimedia services such as messenger/Video On Demand (VOD)/broadcast services by interworking with Electronic-Multimedia Messaging Service (E-MMS) server 140 located in the local area.

Radio Access Station (RAS) 30 provides a physical layer function and a lower Media Access Control (MAC) layer function of the mobile WiMax network. Radio Access Station (RAS) 30 is the same as that of the existing mobile WiMax network.

IP Private Branch eXchange (IP-PBX) 150 serves as a private switch located in a Local Area Network (LAN) and provides an Session Initiation Protocol (SIP) server function for an IP terminal such as mobile WiMax terminal 300-1.

The mobile WiMax network including private access control router 200, Radio Access Station (RAS) 30, and the mobile WiMax terminal is a network in which local subscribers and non-subscribers co-exist. The mobile WiMax network is distinguished from the local intranet network to maintain security. For this, first firewall 120 provides Network Address Translation (NAT) and firewall functions. These functions can be unified with private access control router 200.

In general, Virtual Private Network (VPN) server 160 enables the mobile WiMax subscriber to receive the intranet service in the local area. Virtual Private Network (VPN) server 160 enables the local subscriber to receive the intranet service in an external area, if needed. For this, the Virtual Private Network (VPN) function is provided and mobile WiMax terminal 300-2 remotely accesses the Virtual Private Network (VPN) to receive the local intranet service in the external area. This function can be unified with private access control router 200.

The WiMax Service Management (WSM) server is contemporarily responsible for maintaining and managing access control router 20 and Radio Access Station (RAS) 30. Since private access control router 200 is part of the mobile WiMax network, the WiMax Service Management (WSM) server is responsible for maintaining and managing private access control router 200.

The Authentication, Authorization, and Accounting (AAA) server processes subscriber authentication of mobile WiMax terminal 300-2.

Private network 100 further includes first firewall 120 for authorizing mobile WiMax terminal 300-1 to access private network 100 by setting an IP address of private network 100 registered in WiMax Control Management (WCM) server 110 and assigning the IP address of private network 100 to mobile WiMax terminal 300-1 on the basis of the security policy. First firewall 120 includes the Network Address Translation (NAT) function.

WiMax Control Management (WCM) server 110 of private network 100 manages identification information of mobile WiMax terminal 300-1. That is, the identification information of mobile WiMax terminal 300-1 is stored/deleted/corrected by WiMax Control Management (WCM) server 110.

Private network 100 can further include a private authenticator (not shown) for authenticating mobile WiMax terminal 300-1 registered in WiMax Control Management (WCM) server 110.

Private network 100 is connected to an external Public Switched Telephone Network (PSTN) 2 for providing a voice service through the Voice over IP (VoIP).

Private network 100 further includes Virtual Private Network (VPN) server 160 for providing a Virtual Private Network (VPN) function through Core Node (CN) 170 using one of Point-to-Point Tunneling Protocol (PPTP), Layer Two Tunneling Protocol (L2TP), and Internet Protocol Security protocol (IPSec).

At least one private network 100 is set by information regarding the at least one private network 100 in which mobile WiMax terminal 300-1 is registered.

When an arbitrary mobile WiMax terminal 300-1 or 300-2 performs an authentication procedure of a mobile WiMax network system and makes an IP address assignment request, private access control router 200 determines whether associated mobile WiMax terminal 300-1 is registered in WiMax Control Management (WCM) server 110 in dependence upon identification information of mobile-WiMax terminal 300-1 acquired by communicating with WiMax Control Management (WCM) server 110. When mobile WiMax terminal 300-1 is registered in WiMax Control Management (WCM) server 110, private access control router 200 assigns preset information regarding private network 100 to mobile WiMax terminal 300-1. Herein, the identification information of mobile WiMax terminal 300-1 is a Media Access Control (MAC) address and the present information of private network 100 is about an IP subnet. On the other hand, at least one private network 100 can be set through the IP subnet.

When mobile WiMax terminal 300-2 which is not registered in WiMax Control Management (WCM) server 110 makes an access request, private access control router 200 authenticates mobile WiMax terminal 300-2 through the mobile WiMax network system and then assigns an IP address of the mobile WiMax network to mobile WiMax terminal 300-2.

When a packet is transmitted from an arbitrary mobile WiMax terminal 300-1 or 300-2 to Internet 1, private access control router 200 may route the packet to Internet 1 via Core Node (CN) 170.

Alternatively, when the arbitrary mobile WiMax terminal 300-1 or 300-2 sends the packet to Internet 1, private access control router 200 may route the packet to private network 100 after checking a source IP address of the packet. That is, the source IP address is checked to determine whether mobile WiMax terminal 300-1 or 300-2 sending the packet is mobile WiMax terminal 300-1 which is registered in WiMax Control Management (WCM) server 110.

A description of general functions and operations of the above-described components is omitted. An operation directly related to the invention will be described.

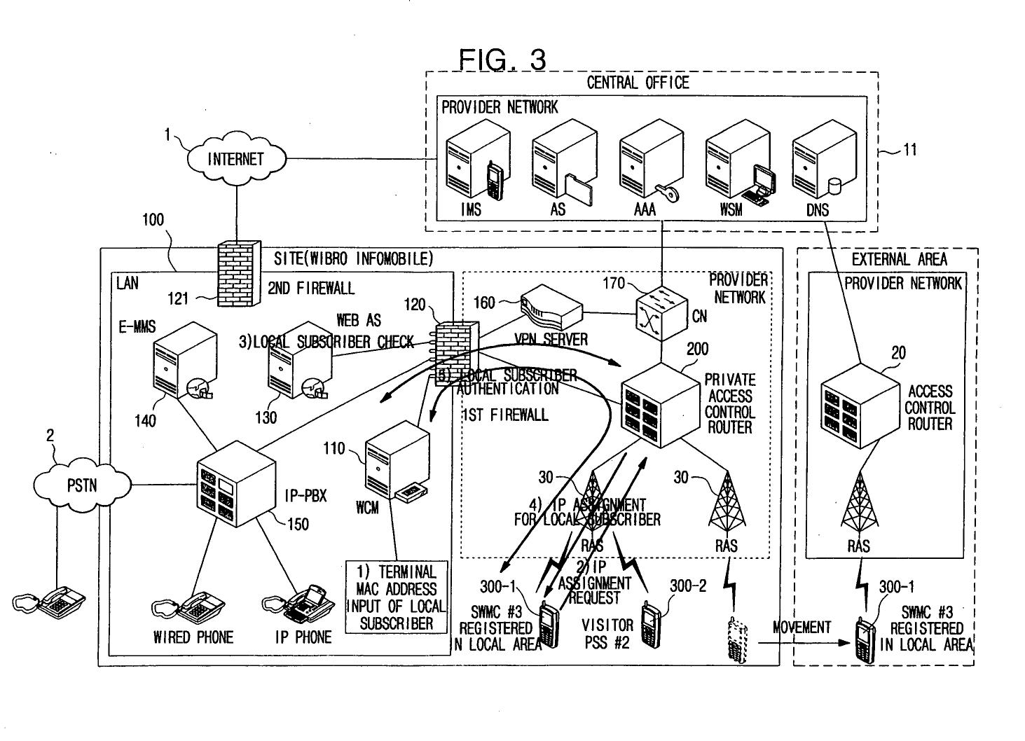

The mobile WiMax network having the private network is shown in FIG. 3. That is, private network 100 including WiMax Control Management (WCM) server 110 is connected to private access control router 200 through first firewall 120.

WiMax Control Management (WCM) server 110 of private network 100 registers a Media Access Control (MAC) address of mobile WiMax terminal 300-1 for constructing private network 100. WiMax Control Management (WCM) server 110 has a management function for registering/correcting/deleting the Media Access Control (MAC) address of mobile WiMax terminal 300-1 to construct private network 100.

Private network 100 included in the mobile WiMax network system is connected to private access control router 200 and is connected to mobile WiMax terminal 300-1 or 300-2 through Radio Access Station (RAS) 30.

When an arbitrary mobile WiMax terminal 300-1 or 300-2 sends an access request through Radio Access Station (RAS) 30 connected to private access control router 200 in the mobile WiMax network system including private network 100, private access control router 200 performs mobile WiMax authentication of the associated mobile WiMax terminal 300-1 or 300-2 sending the access request. Herein, the mobile WiMax authentication of mobile WiMax terminal 300-1 or 300-2 is an initial authentication procedure based on a mobile WiMax standard and is the same operation as that of access control router 20 in the contemporary mobile WiMax network system.

That is, private access control router 200 accesses the Authentication, Authorization, and Accounting (AAA) server of the mobile WiMax network system to perform the mobile WiMax authentication of mobile WiMax terminal 300-1 or 300-2 requesting the access and then performs the mobile WiMax authentication of mobile WiMax terminal 300-1 or 300-2.

Then, private access control router 200 assigns an IP address to mobile WiMax terminal 300-1 or 300-2 after performing the mobile WiMax authentication. If mobile WiMax terminal 300-1 or 300-2 sending the access request to private access control router 200 is not mobile WiMax terminal 300-1 registered in WiMax Control Management (WCM) server 110, an IP address to be used in the mobile WiMax network is assigned and simultaneously private network information (about an IP subnet different from private network 100) is assigned.

If mobile WiMax terminal 300-1 or 300-2 sending the access request is mobile WiMax terminal 300-1 registered in WiMax Control Management (WCM) server 110 of private network 100, private access control router 200 assigns an IP address and simultaneously assigns private network information (about an IP subnet corresponding to private network 100).

A method in which private access control router 200 determines whether mobile WiMax terminal 300-1 requesting the access is registered in private network 100 can be identified through a communication with WiMax Control Management (WCM) server 110 for managing mobile WiMax terminal 300-1 in private network 100.

After mobile WiMax terminal 300-1 is authenticated and assigned an IP address, private access control router 200 checks a destination address of a packet to route the packet when the packet is sent from an arbitrary mobile WiMax terminal 300-1 or 300-2.

If the packet is destined to an arbitrary wired phone or IP phone (not denoted by reference numeral) of private network 100, private access control router 200 sends the packet to first firewall 120 serving as a gateway of private network 100.

Herein, first firewall 120 performs a security policy based on an IP address assigned to mobile WiMax terminal 300-1 registered in WiMax Control Management (WCM) server 110 by private access control router 200 and information of private network 100 (about an IP subnet). That is, first firewall 120 passes the associated packet to private network 100 if a source IP address of the packet received from private access control router 200 includes the IP subnet corresponding to private network 100. Since the source IP address includes an IP subnet different from private network 100 if the packet is sent from mobile WiMax terminal 300-2 which is not registered in WiMax Control Management (WCM) server 110, the packet is discarded without passing through private network 100.

If the packet is sent from mobile WiMax terminal 300-1 registered in WiMax Control Management (WCM) server 110, the packet can be provided to private network 100 through first firewall 120. If the packet is sent from mobile WiMax terminal 300-2 which is not registered in WiMax Control Management (WCM) server 110, however, the packet is intercepted by first firewall 120 without being sent to private network 100.

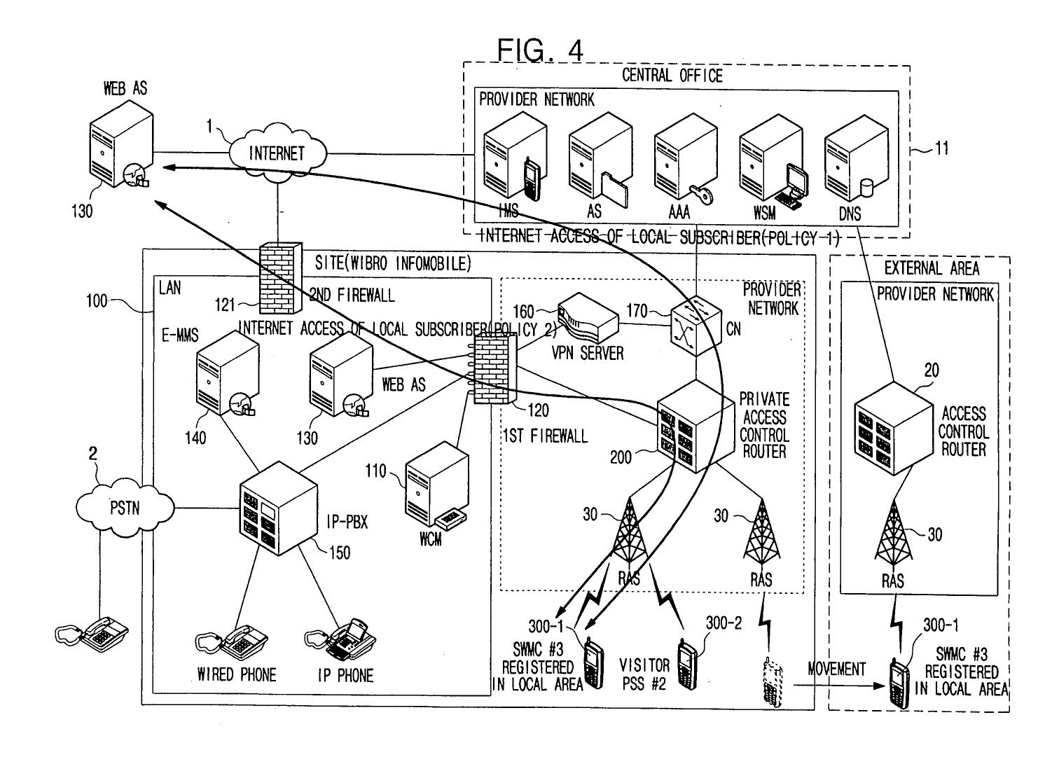

A case where a packet destination is the external Internet 1 will be described with reference to FIG. 4. If the packet is sent from mobile WiMax terminal 300-1 relating to the IP subnet corresponding to private network 100 to private access control router 200, private access control router 200 sends the packet to the external Internet 1 after checking the packet.

At this time, private access control router 200 receives the packet through Radio Access Station (RAS) 30 according to setting of a manager, thereby sending the received packet to Internet 1 either through Core Node (CN) 170 of the mobile WiMax network system or through private network 100.

If private access control router 200 is set to send the packet to Internet 1 through private network 100, private access control router 200 sends the packet received from Radio Access Station (RAS) 30 to first firewall 120 of private network 100.

First firewall 120 receiving the packet from private access control router 200 determines whether there is IP subnet information corresponding to private network 100 and then determines whether to pass the packet.

Accordingly, if mobile WiMax terminal 300-1 sending the packet is registered in WiMax Control Management (WCM) server 110 and is assigned an IP subnet corresponding to private network 100, the associated packet is passed. If mobile WiMax terminal 300-1 is assigned an IP subnet different from private network 100, the associated packet is intercepted.

When private access control router 200 is set to send the packet to Internet 1 through private network 100, only mobile WiMax terminal 300-1 registered in WiMax Control Management (WCM) server 110 can access external Internet 1. Mobile WiMax terminal 300-2 which is not registered in WiMax Control Management (WCM) server 110 cannot access external Internet 1. Accordingly, security can be provided for mobile WiMax terminal 300-1 using private network 100.

If private access control router 200 is set to send the packet to Internet 1 through the mobile WiMax network system, private access control router 200 sends the packet to external Internet 1 through Core Node (CN) 170 of the mobile WiMax network system rather than private network 100.

If private access control router 200 is set as described above, every mobile WiMax terminal 300-1 or 300-2 can access Internet 1.

On the other hand, if the arbitrary mobile WiMax terminal 300-1 or 300-2 attempts to access mobile WiMax terminals of private network 100, private access control router 200 checks the source IP address of the associated packet to route the packet.

After the destination IP address of the packet sent from the arbitrary mobile WiMax terminal 300-1 or 300-2 is checked, the packet is routed to private network 100.

Then, private network 100 receives the associated packet through first firewall 120. First firewall 120 checks an IP subnet of the source IP address of the associated packet. The associated packet is passed only when the IP subnet corresponds to private network 100. That is, if the terminal is registered in WiMax Control Management (WCM) server 110 and is assigned the IP subnet corresponding to private network 100, the associated packet is passed to private network 100. If the packet is sent from mobile WiMax terminal 300-2 assigned an IP subnet different from private network 100, the packet is intercepted.

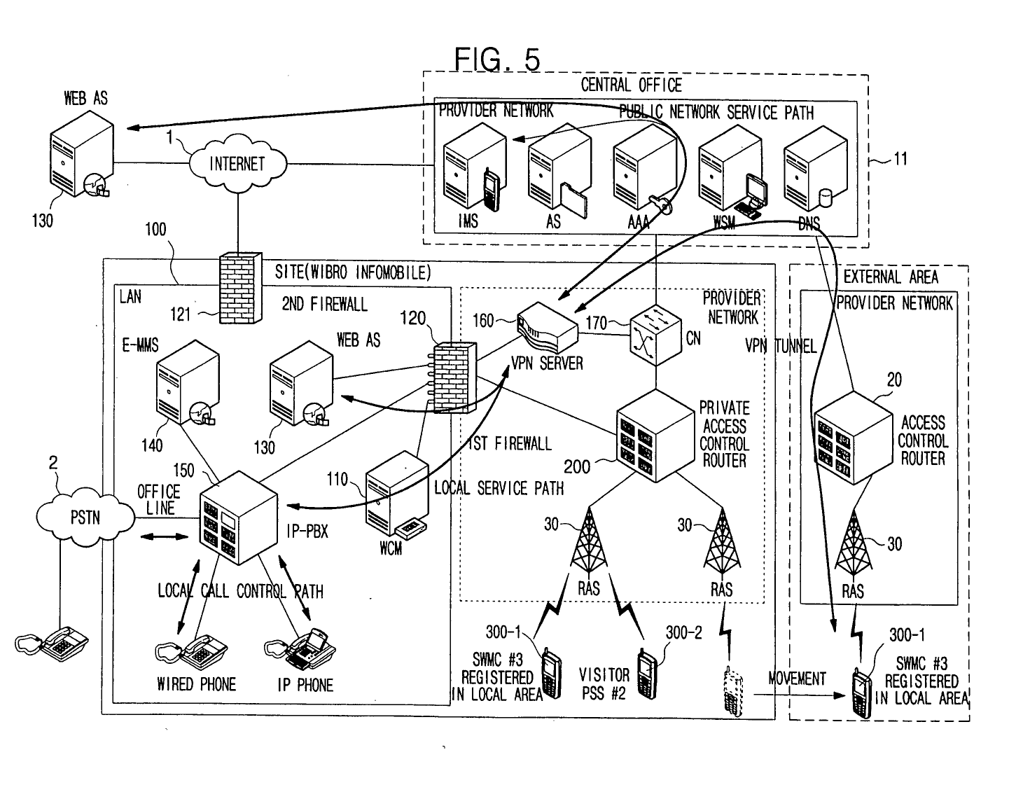

An operation in which the mobile WiMax terminal connected to the mobile WiMax network accesses the private network will be described with reference to FIG. 5.

In FIG. 5, an arbitrary mobile WiMax terminal 300-1 or 300-2 located in an external area attempts to remotely access private network 100 through Radio Access Station (RAS) 30 and access control router 20 of the mobile WiMax network. At this time, the packet is sent through access control router 20 of the mobile WiMax network and an access to private network 100 through a provider network of the mobile WiMax network is attempted.

In order to access private network 100 through access control router 20 of the mobile WiMax network, remote access is performed through Virtual Private Network (VPN) server 160 connected to private network 100. Herein, a method for accessing Virtual Private Network (VPN) server 160 contemporarily uses technologies of Point-to-Point Tunneling Protocol (PPTP), Layer Two Tunneling Protocol (L2TP), and Internet Protocol Security protocol (IPSec), and WiMax Control Management (WCM) server 110 performs Remote Authentication Dial In User Service/Certificate Authority (RADIUS/CA) function for subscriber authentication.

On the other hand, remote control is performed through Virtual Private Network (VPN) server 160 from access control router 20 of the mobile WiMax network system.

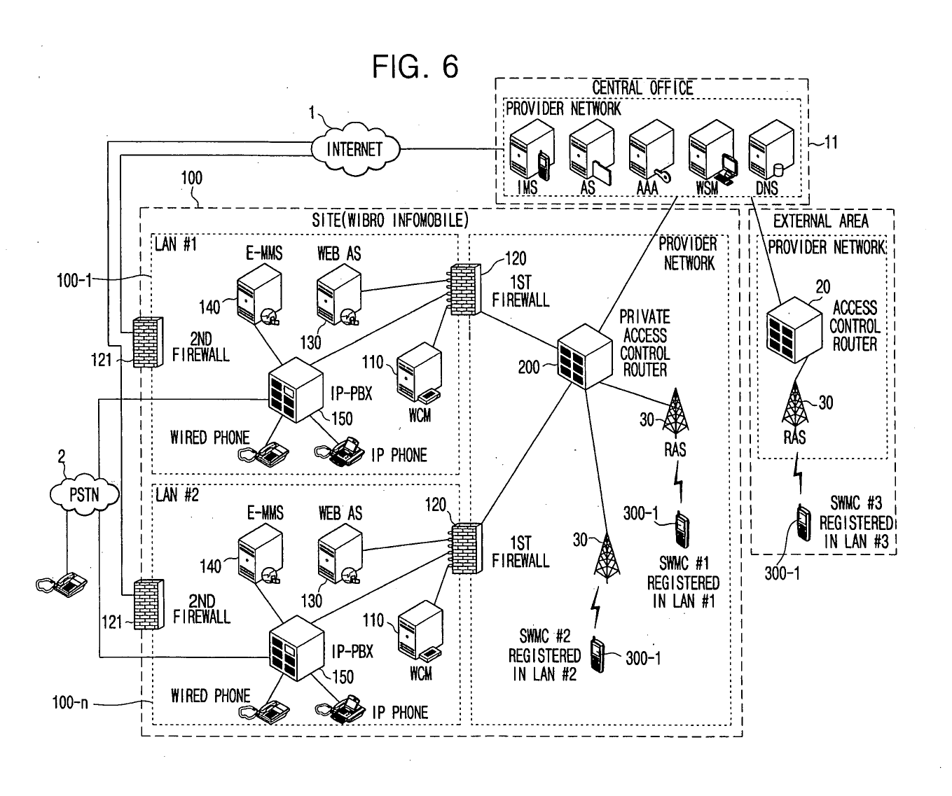

When private network 100 is configured with multiple sites, private access control router 200 assigns IP addresses by setting site-by-site IP subnets as shown in FIG. 6.

When the site-by-site IP subnets are set, the site can be managed according to at least one of private networks 100-1 and 100-n.

Private access control router 200 checks an IP subnet of a received packet and routes the received packet to the associated private network 100-1 or 100-n. First firewall 120 of the associated private network 100 determines whether to pass the packet.

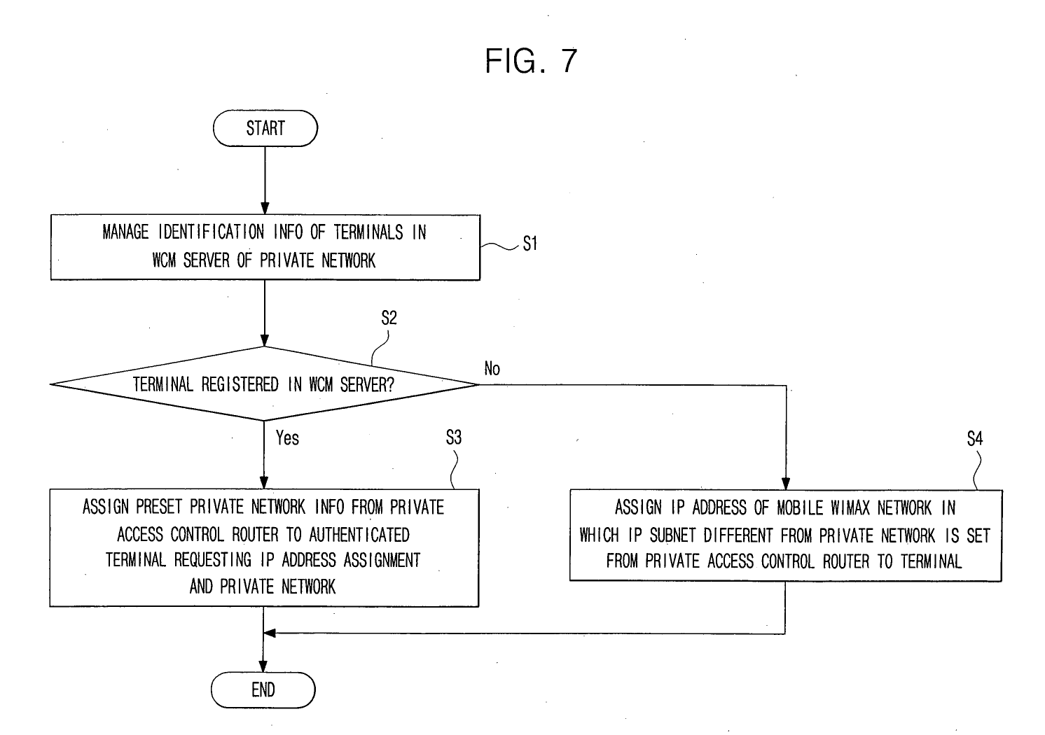

A control method of the mobile WiMax network system including the private network in accordance with the invention having the above-described configuration will be described with reference to FIG. 7.

First, WiMax Control Management (WCM) server 110 of private network 100 manages identification information of mobile WiMax terminal 300-1 (step S1). Herein, the identification information of mobile WiMax terminal 300-1 is a Media Access Control (MAC) address.

After performing mobile WiMax authentication of an arbitrary mobile WiMax terminal 300-1 or 300-2 requesting the access, private access control router 200 determines whether the associated terminal is mobile WiMax terminal 300-1 registered in WiMax Control Management (WCM) server 110 in dependence upon the identification information of mobile WiMax terminal 300-1 or 300-2 acquired by communicating with WiMax Control Management (WCM) server 110 (step S2).

If the associated terminal is determined to be mobile WiMax terminal 300-1 registered in WiMax Control Management (WCM) server 110 (that is, “YES” in step S2 when determining whether the associated terminal is registered in WiMax Control Management (WCM) server 110), private access control router 200 assigns preset information of private network 100 to both of the authenticated mobile WiMax terminal 300-1 requesting IP address assignment and private network 100 (step S3). Herein, the information of private network 100 is at least one of IP subnet information and an IP address in an IP subnet range.

On the other hand, if the associated terminal is determined not to be the mobile WiMax terminal 300-1 registered in WiMax Control Management (WCM) server 110 (that is, “NO” in step S2 of determining whether the associated terminal is registered in WiMax Control Management (WCM) server 110), private access control router 200 assigns to mobile WiMax terminal 300-2 an IP address of the mobile WiMax network in which an IP subnet different from private network 100 is set (S4).

In the above-described method, first firewall 120 of private network 100 authorizes mobile WiMax terminal 300-1 to access private network 100 by setting an IP address of private network 100 registered in WiMax Control Management (WCM) server 110 and assigned to mobile WiMax terminal 300-1 on the basis of the security policy.

When a packet destined to Internet 1 is received from the arbitrary mobile WiMax terminal 300-1 or 300-2, private access control router 200 routes the packet to Internet 1 through the Core Node (CN) or routes the packet to Internet 1 through private network 100 after checking a source IP address of the packet. This can be changed according to routing policy of the manager.

While the invention has been shown and described in connection with the preferred embodiments, it will be apparent to those skilled in the art that modifications and variations can be made without departing from the spirit and scope of the invention as defined by the appended claims.

What is claimed is:

1. A mobile Worldwide Interoperability for Microwave Access (WiMax) network system, comprising:
a private network interworking with the WiMax network system, and comprising a WiMax Control Management (WCM) server for managing identification information of terminals; and
a private access control router for determining whether an arbitrary terminal is registered in the WiMax Control Management (WCM) server through identification information of the terminal acquired by communicating with the WiMax Control Management (WCM) server when the terminal requests Internet Protocol (IP) address assignment after an authentication procedure of the mobile WiMax network system is performed, and assigning preset private network information to the terminal and to the private network when the terminal is registered.

2. The mobile WiMax network system according to claim 1, comprised of the identification information of the terminal being a media access control address.

3. The mobile WiMax network system according to claim 1, comprised of the private network information being at least one of IP subnet information and an IP address in an IP subnet range.

4. The mobile WiMax network system according to claim 1, comprised of the private network further comprising a first firewall for authorizing the terminal to access the private network by setting a private network IP address registered in the WiMax Control Management (WCM) server and assigning the private network IP address to the terminal with reference to a security policy.

5. The mobile WiMax network system according to claim 1, comprised of the private access control router assigning an IP address of the mobile WiMax network to a terminal after the terminal is authenticated through the mobile WiMax network when the terminal which is not registered in the WiMax Control Management (WCM) server makes an access request.

6. The mobile WiMax network system according to claim 1, comprised of the private network further comprising a private authenticator for authenticating a registered terminal.

7. The mobile WiMax network system according to claim 5, comprised of the private access control router routing a packet to an Internet through a core node when the packet destined to the Internet is sent from an arbitrary terminal.

8. The mobile WiMax network system according to claim 5, comprised of the private access control router routing a packet to an Internet through the private network after checking a source IP address of the packet when the packet destined to the Internet is sent from an arbitrary terminal.

9. The mobile WiMax network system according to claim 4, comprised of the private network further comprising an IP-private branch exchange based on a session initiation protocol connected to an external public switched telephone network to provide a voice service through a voice over IP.

10. The mobile WiMax network system according to claim 1, comprised of the private network further comprising a Virtual Private Network (VPN) server connected to a core node for providing a Virtual Private Network (VPN) function using one of a point-to-point tunneling protocol, a layer two tunneling protocol, and an Internet protocol security protocol.

11. The mobile WiMax network system according to claim 3, comprised of the private network being set to at least one private network through the private network information of the terminals.

12. A control method of a mobile Worldwide Interoperability for Microwave Access (WiMax) network system interworking with a private network, comprising:
managing identification information of terminals in a WiMax Control Management (WCM) server of the private network;
determining, by a private access control router, whether an arbitrary terminal is registered in the WiMax Control Management (WCM) server in dependence upon identification information of the terminal acquired by communicating with the WiMax Control Management (WCM) server after mobile WiMax authentication is performed for the terminal requesting access; and
assigning preset private network information from the private access control router to the terminal which requests IP address assignment and is authenticated through the mobile WiMax authentication and to the private network when the terminal is determined to be registered.

13. The control method according to claim 12, comprised of the identification information of the terminal being a media access control address.

14. The control method according to claim 12, comprised of the private network information being at least one of IP subnet information and an IP address in an IP subnet range.

15. The control method according to claim 13, further comprising:
authorizing, by a first firewall, the terminal to access the private network by setting a private network IP address registered in the WiMax Control Management (WCM) server and assigned to the terminal with reference to a security policy.

16. The control method according to claim 13, further comprising:
assigning an IP address of the mobile WiMax network from the private access control router to a terminal after the terminal is authenticated through the mobile WiMax network when the terminal which is not registered in the WiMax Control Management (WCM) server makes an access request.

17. The control method according to claim 16, further comprising:
routing a packet from the private access control router to an Internet through a core node when the packet destined to the Internet is sent from an arbitrary terminal.

18. The control method according to claim 16, further comprising:
routing a packet from the private access control router to the private network after checking a source IP address of the packet when an arbitrary terminal sends the packet destined to an Internet.

19. The control method according to claim 13, further comprising:
accessing a code node through a Virtual Private Network (VPN) server in an external mobile WiMax network and providing a Virtual Private Network (VPN) function using one of a point-to-point tunneling protocol, a layer two tunneling protocol, and an Internet protocol security protocol.

20. The control method according to claim 14, wherein assigning the IP address and the private network information includes:
setting at least one private network through the private network information of the terminals.
